(19) United States
(12) Patent Application Publication
(10) Pub. No.: US 2020/0093169 A1
(43) Pub. Date: Mar. 26, 2020

(54) FRUIT PRESS FOR CITRUS FRUITS

(71) Applicant: Citrocasa GmbH, Linz (AT)

(72) Inventors: Johannes Edtmayr, Prambachkirchen (AT); Johannes Huber, Luftenberg (AT)

(73) Assignee: Citrocasa GmbH, Linz (AT)

(21) Appl. No.: 16/574,175

(22) Filed: Sep. 18, 2019

(30) Foreign Application Priority Data
Sep. 20, 2018 (AT) A50806/2018

(51) Int. Cl. A23N 1/02; B30B 9/04; B30B 15/08

(52) U.S. Cl. CPC A23N 1/02; B30B 15/08; B30B 9/04

(57) ABSTRACT

A fruit press for citrus fruits may have a press head which carries out a press stroke and which may have two receiving dies arranged on both sides of a knife, and may be pivotable in opposite directions via parallel shafts between an upper receiving position and a lower pressing position for one half-fruit each. The fruit press may include two sliding guides for the half-fruits extending on both sides of the knife and following the outer orbital path of the receiving dies, and may further include punches which are associated with the press head and which, in the lower press position of the press head, cooperate with the receiving dies. The sliding guides may have flexurally elastic slideways which project into the effective region of the punches and which may be bent out into the receiving dies by the punches during the pressing stroke.

### TECHNICAL FIELD

This application relates to a fruit press, and more particularly to a fruit press for citrus fruits.

### BACKGROUND OF THE INVENTION

PCT patent application WO 2015/024034 A1 describes a fruit press in which the pressing tools are formed from fixed lower punches and receiving dies cooperating with these punches, which can be pivoted between an upper receiving position for the fruit and a lower pressing position. In such a fruit presses, there are structural advantages with regard to the overall width, because the receiving dies are only pivoted back and forth in opposite directions between the receiving position and the pressing position and do not rotate in opposite directions. When the receiving dies are pivoted downwards into the pressing position, the citrus fruits are halved with the aid of a knife fixed between the receiving dies and are then pressed out in the lower pressing position by the punches penetrating into the receiving dies. In order to prevent the fruit halves from exiting the receiving dies before the punches are used, the receiving dies are assigned sliding guides for the fruit halves, which are entrained along these sliding guides by the receiving dies. In the lower pressing position of the receiving dies, the punches prevent the fruit halves from escaping from the receiving dies when the fruit halves slide with the cut surface from the sliding guides onto the punches. However, this prevention can only be ensured for citrus fruits which have a size adapted to the recording dies. Since the sliding guides have to be moved past the punches during the press stroke so that the punches can engage in the receiving dies, there is a risk that the fruit halves of smaller citrus fruits will tip over from the sliding guides during the press stroke before they are supported by the punches, so that the fruit halves are pressed in a tilted position, which should be avoided as far as possible.

The same disadvantages also occur with another well-known fruit press based on the same functional principle (see DE 693 15 802 T2), in which the halves of the divided citrus fruits are guided along a sliding ramp to a ramp opening by means of the receiving dies, through which the punches can intervene in the receiving dies during the press stroke. Before the punches close these ramp openings during the press stroke, there is again the danger that the fruit halves tilt in the area of the ramp openings and cannot be pressed out properly.

### SUMMARY OF THE INVENTION

Described herein is a fruit press configured and arranged to properly press smaller citrus fruits. The fruit press described herein may have sliding guides that have flexurally elastic slideways which project into the effective region of the punches and may be bent out into the receiving dies by the punches during the press stroke.

For sliding guides having such flexurally elastic slideways, a free space in the sliding guides required for the punches to enter the receiving dies may be at least partially covered by the flexurally elastic slideways, and the fruit halves may slide on their cut surface along the slideways extending the sliding guides into the effective area of the punches without being exposed to any risk of tipping otherwise occurring when leaving the sliding guides. The fruit halves, which may be held in a position favorable for the press stroke by means of the slideways independent of the diameter of their cut surfaces, thus may be pressed by the press head onto the punches, which press the fruit halves into the die receptacles with the slideways entrained. As a result, the flexurally elastic slideways, which may be applied to the punches, should not impede the pressing process, although they may project into the effective area of the punches.

Although the flexurally elastic slideways may be exposed to compressive forces, they may easily absorb such compressive forces. Nevertheless, it may be desirable that these slideways be arranged so that they have be replaced as wear parts. For this purpose, the slideways may be exchangeably connected to the sliding guides, which may require appropriate design measures in the area of the sliding guides. Alternatively, the sliding guides provided with the slideways may be exchangeably arranged on the press head.

### BRIEF DESCRIPTION OF THE DRAWINGS

The fruit press described herein will be explained in more detail below on the basis of illustrative embodiments using drawings that show the subject matter of the invention by way of example. In the figures:

FIG. 1 shows a schematic illustration of a fruit press for citrus fruits, from a view perpendicular to the shafts of the receiving dies in an upper receiving position, according to an embodiment of the fruit press described herein;

FIG. 2 shows a schematic illustration of a fruit press for citrus fruits, from a view perpendicular to the shafts of the receiving dies in an a first intermediate position, according to an embodiment of the fruit press described herein;

FIG. 3 shows a schematic illustration of a fruit press for citrus fruits, from a view perpendicular to the shafts of the receiving dies in an a second intermediate position, according to an embodiment of the fruit press described herein; and

FIG. 4 shows a schematic illustration of a fruit press for citrus fruits, from a view perpendicular to the shafts of the receiving dies in a lower pressing position, according to an embodiment of the fruit press described herein.

### DESCRIPTION OF VARIOUS EMBODIMENTS

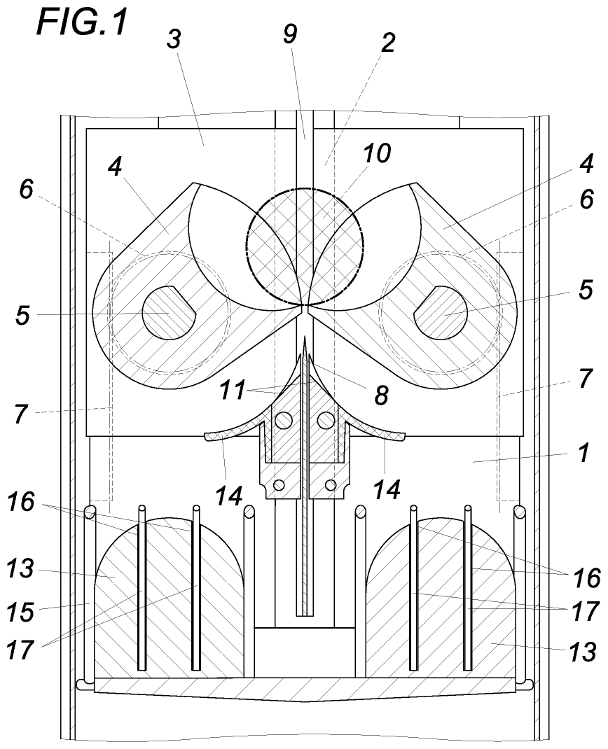

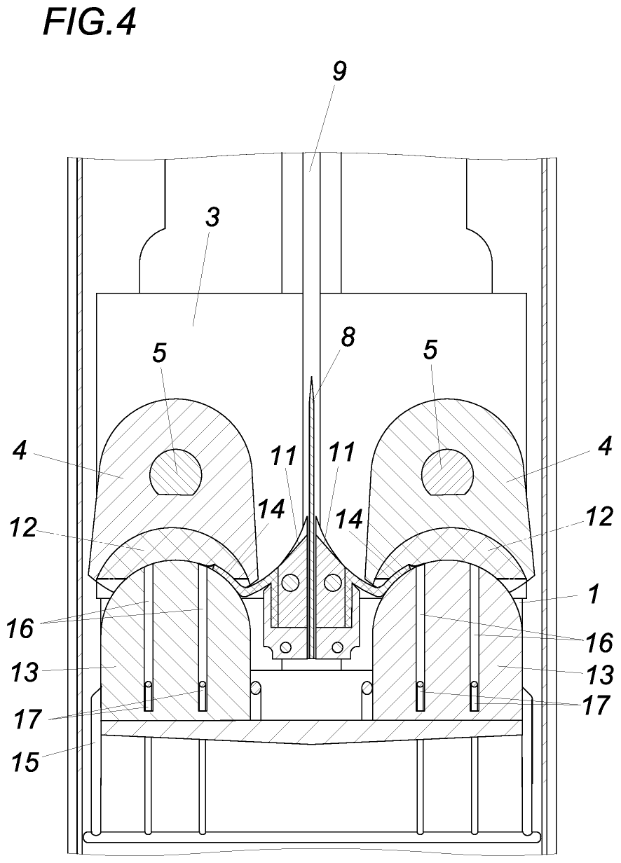

The fruit press for citrus fruits shown here may have a frame 1, which forms a guide 2 for a press head 3 extending at height. This press head 3 may be driven along guide 2 by means of a press drive. In the press head 3, there may be two receiving dies 4 mounted on parallel shafts 5, which carry a drive pinion 6. The drive pinions 6 may mesh with toothed racks 7 attached laterally to the frame 1 so that when the press head 3 is shifted along the guide 2, the drive pinions 6 rolling on the toothed racks 7 pivot the receiving dies 4 during the press stroke from the upper receiving position shown in FIG. 1 into the lower pressing position according to FIG. 4, and pivot the receiving dies 4 during the empty stroke from the lower pressing position back again into the receiving position.

A knife 8 may be attached to the frame 1 between the two receiving dies 4 with the aid of a knife carrier 9 which overlaps the press head 4. Sliding guides 11 for the fruit halves 12 may be assigned to the receiving dies 4 on the press head 3 so that the citrus fruits, which may be fed to the receiving dies 4 via a feed channel, cannot slide out of the receiving dies 4 due to gravity after cutting during the pivoting movement of the receiving dies 4 in the opposite direction. These sliding guides 12 may form a guide between them for the knife 8.

Below the receiving dies 4, punches 13 may be provided in the frame 1, which interact with the receiving dies 4 in the lower pressing position, as shown in FIG. 4. If the receiving dies 4 loaded with the fruit halves 12 are lowered to the punches 13 during the press stroke of the press head 3, the fruit halves 12 may be pressed out between the punches 13 and the receiving dies 4. The squeezed juice may be collected in a juice chamber and may be removed via a stopcock.

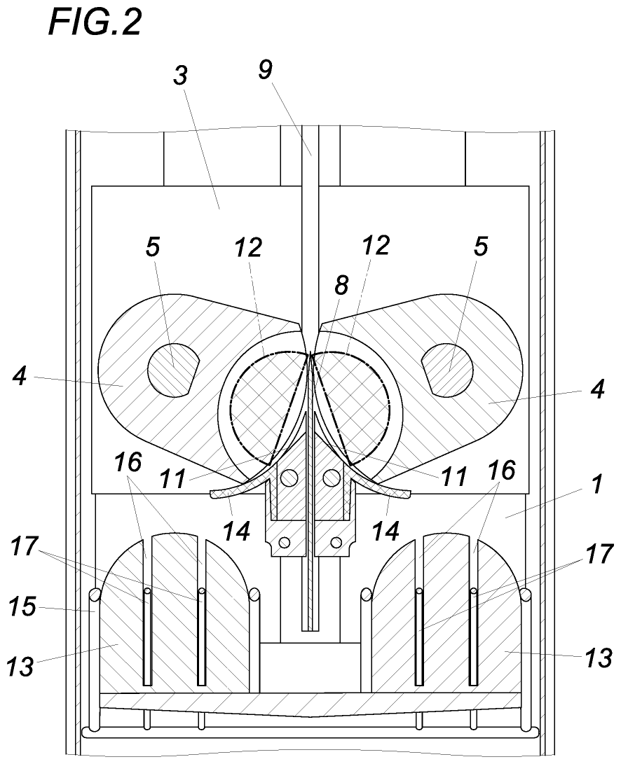

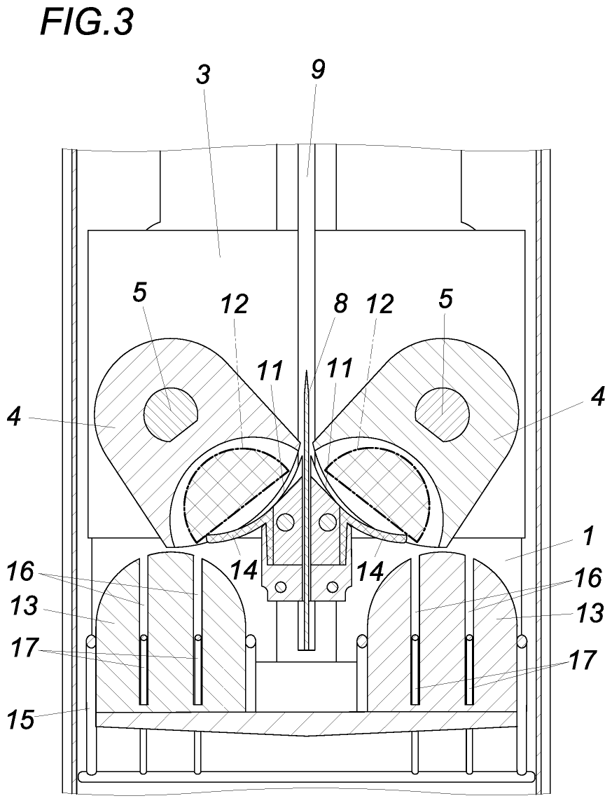

In order to hold the half-fruits 12 in an advantageous position for the subsequent pressing process with the cut surface facing downwards towards the punch 13, the sliding guides 11 may be provided with flexurally elastic slideways 14 protruding into the effective area of the punch 13. As may be seen from the intermediate positions according to FIGS. 2 and 3, there may be a risk that, in the case of sliding guides 11 without the slideways 14 that extend them, for citrus fruits 10 with a smaller diameter, the half-fruits 12 may tip over in the free space required for the sliding guides to move past the punches 13 before the half-fruits 12 with their cut surface may support themselves on the punches 13. As a result, that the half-fruits 12 may not caught by the punches 13 in the area of the cut surface, but rather in the peel area, which may be desirable to avoid. The slideways 14 may extend the guidance of the half-fruits 12 on their cut surfaces into the effective area of the punches 13 so that the half-fruits 12 come to rest with their cut surfaces on the punches 13 and are therefore properly pressed with the peels first into the receiving dies 4.

It may be desired, however, that the slideways 14 protruding into the effective area of the punches 13 do not hinder the pressing process. This may be achieved in a simple way in that the slideways 14 may be formed in a flexurally elastic manner and bent out by the punches 13 into the receiving dies 4, as shown in FIG. 4. The flexurally elastic slideways 14 may be loaded by the pressing forces under pressure, so that at most a wear load can be expected which makes it necessary to replace the flexurally elastic slideways 14. For this purpose, the slideways 14 may either be detachably connected to the sliding guides 11 or may be kept interchangeable with the sliding guides 11 in accordance with the embodiments of the fruit press described herein.

In order to be able to lift the pressed half-fruits 12 from the punches 13 and discharge them into a collecting container, a discharge device may be provided, which may be formed from a discharge comb 15 according to embodiments of the fruit press described herein. The punches 13 may be provided with grooves 16 aligned in the direction of the shafts 5 of the receiving dies 4 to receive the fingers 17 of the discharge comb 15, which may be articulated around an articulation axis on the press head 3. Since the linkage of the discharge comb 15 may be provided on the front side of the sliding guides 11 facing the user, the discharge comb 15 may descend backwards in the raised, stop-limited discharge position according to FIG. 1 below the slideways 14 to a discharge opening leading into the collecting container. When the press head 3 is lowered into the pressing position, the discharge comb 15 may strike against a sliding stop fixed to the frame and may be thereby pivoted upwards about its upper articulation axis when the press head 3 is lowered further, thus saving overall height. In the lowered pressing position according to FIG. 4, the fingers 17 of the discharge comb 15 may be countersunk in the grooves 16 of the punches 13, so that pressing out the half-fruits 12 may not be hindered by the discharge device. If, after the press stroke, the press head 3 is lifted in an empty stroke, the discharge comb 15 may be first pivoted into the stop-limited pivoting position of the discharge position, taking the peel halves remaining on the punches 18 with it, and lifted over the punch 13, so that the peels halves fall into the collecting container along the descending fingers 17.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A fruit press for citrus fruits comprising:
a press head which carries a press stroke and which comprises two receiving dies which are arranged on both sides of a knife, and are pivotable in opposite directions via parallel shafts between an upper receiving position and a lower pressing position and are each intended for one half-fruit;
two sliding guides for the half-fruits which extend on both sides of the knife and follow the outer orbital path of the receiving dies; and
punches assigned to the press head and that cooperate with the receiving dies in the lower press position of the press head, wherein the sliding guides have flexurally elastic slideways which project into an effective region of the punches and are bendable into the two receiving dies by the punches during the press stroke.

2. The fruit press according to claim 1, wherein the slideways are exchangeably connected to the sliding guides.

3. The fruit press according to claim 1, wherein the sliding guides provided with the slideways are arranged exchangeably on the press head.

4. A fruit press comprising:
a knife for cutting a fruit into two pieces of the fruit;
a press head including two receiving dies, each receiving dies arranged on a respective side of the knife, wherein each of the two receiving dies are pivotable in an opposite direction from the other of the two receiving dies, between an upper position for receiving one of the two pieces of fruit and a lower position for pressing the one piece of fruit;
two sliding guides for the two pieces of fruit, each of the two sliding guides extend on a respective side of the knife and following an outer orbital path of a respective one of the two receiving dies; and
punches that cooperate with the two receiving dies when each of the two receiving die is in the lower position for pressing the one piece of fruit, the punches contacting the pieces of fruit in an effective region when each of the two receiving die is in the lower position, wherein each of the two sliding guides has a flexible slideway that projects into the effective region and that bends into a respective one of the two receiving dies when contacted by one or more of the punches when the respective one of the receiving die is in the lower position.

5. The fruit press according to claim 4, wherein each flexible slideway is exchangeably connected to the respective sliding guide of the flexible slideway.

6. The fruit press according to claim 4, wherein the two sliding guides are arranged exchangeably on the press head.
